(19) United States
(12) Patent Application Publication
(10) Pub. No.: US 2008/0083200 A1
(43) Pub. Date: Apr. 10, 2008

(54) AIR FILTER FOR A MOTORCYCLE

(75) Inventors: Erick L. Gruber, Rubicon, WI (US); Anthony D. Stefanelli, Elkhorn, WI (US)

Correspondence Address: MICHAEL BEST & FRIEDRICH LLP, 100 E WISCONSIN AVENUE, Suite 3300, MILWAUKEE, WI, 53202, US

(73) Assignee: BUELL MOTORCYCLE COMPANY, East Troy, WI (US)

(21) Appl. No.: 11/539,823

(22) Filed: Oct. 9, 2006

(51) Int. Cl. B01D 46/00

(52) U.S. Cl. 55/385.3

(57) ABSTRACT

An air filter assembly for a motorcycle includes a housing at least partially defining an air intake passageway. The housing includes an opening a curved surface adjacent to the opening. An air filter is formed to be substantially planar in an unrestrained condition and deformed against the curved surface to conform to the curved surface. A retention mechanism retains the air filter against the curved surface.

### BACKGROUND

The present invention relates to air filters for motorcycles.

### SUMMARY

In one embodiment, the invention provides an air filter assembly for a motorcycle including an engine having an air intake passageway. The air filter assembly includes a housing at least partially defining the air intake passageway, the housing including an opening and a curved surface adjacent to the opening. An air filter is formed to be substantially planar in an unrestrained condition, the air filter deformed against the curved surface to conform to the curved surface. A retention mechanism retains the air filter against the curved surface.

In another embodiment, the invention provides a motorcycle including, among other things, an engine configured to provide power to a wheel of the motorcycle. An air box is configured to direct intake air into the engine. The air box includes an air filter having a pre-assembled condition and an assembled condition, the air filter being substantially flat and unstressed in the pre-assembled condition and having a curved orientation in the assembled condition. The air box further includes a housing including a curved surface, wherein the air filter is deformed against the curved surface to conform to the curved surface when the air filter is in the assembled condition.

In yet another embodiment the invention provides a method of assembling a motorcycle having an engine. The method includes providing an air box housing configured to route intake air to a throttle assembly of the engine, providing a substantially non-curved air filter, the air filter being flat in an unstressed state, and mounting the air filter to the air box housing in a curved orientation.

Other aspects of the invention will become apparent by consideration of the detailed description and accompanying drawings.

### BRIEF DESCRIPTION OF THE DRAWINGS

FIG. 1 is a perspective view of a motorcycle including an air box;

FIG. 2 is an exploded assembly view of the air box shown in FIG. 1;

FIG. 3 is a rear perspective view of the air box shown in FIGS. 1 and 2 with the upper housing removed;

FIG. 4 is a top view of the air box shown in FIG. 3;

FIG. 5 is an exploded assembly view of an air box according to a second embodiment of the present invention;

FIG. 6 is a perspective view of the air box shown in FIG. 5;

FIG. 7 is a cross-sectional view of the air box taken along line 7-7 of FIG. 6;

FIG. 8 is a partial cross-sectional view of the air box taken along line 8-8 of FIG. 6;

FIG. 9 is an exploded assembly view of an air box according to a third embodiment;

FIG. 10 is a perspective view of the air box shown in FIG. 9; and

FIG. 11 is a cross-sectional view of the air box taken along line 11-11 of FIG. 10.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

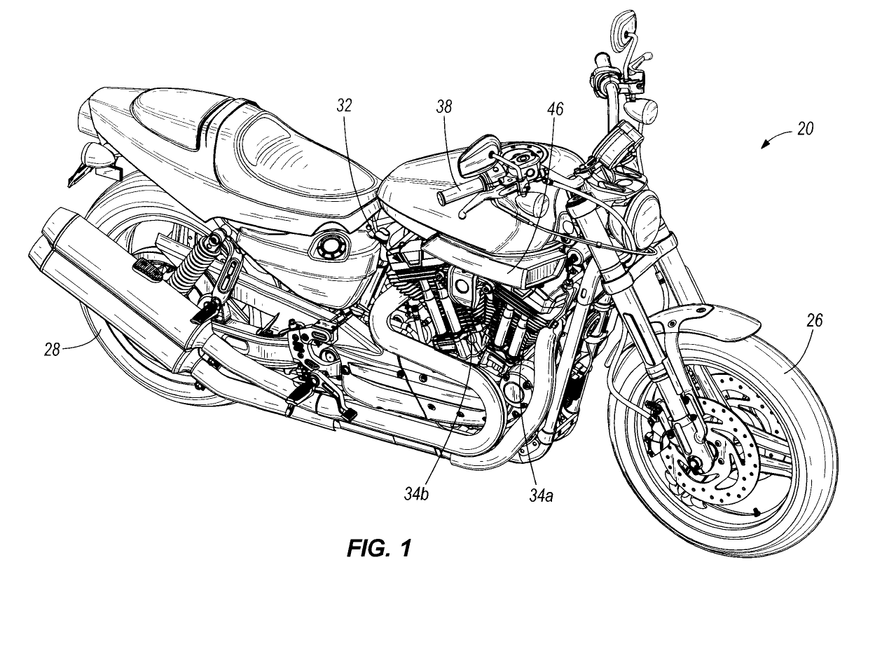

The motorcycle 20 of FIG. 1 includes a front wheel 26, a rear wheel 28, and an engine 32. The engine 32 provides power to the rear wheel 28 through a transmission. The engine 32 includes two cylinders 34a, 34b for combusting an air-fuel mixture. The crankshaft rotational speed (or simply “engine speed”) is controlled by a throttle control 38, which is coupled either mechanically or electro-mechanically to a throttle assembly (not shown). The throttle control 38 is a grip control that is rotated by a rider's right hand.

As understood by one skilled in the art, the throttle assembly includes a throttle body defining a flow passage and a throttle plate within the flow passage. The throttle plate is movable between a substantially closed (i.e., “idle”) position and a substantially fully open (i.e., “full throttle”) position in response to the throttle control 38 being rotated from an at-rest position to a full throttle position.

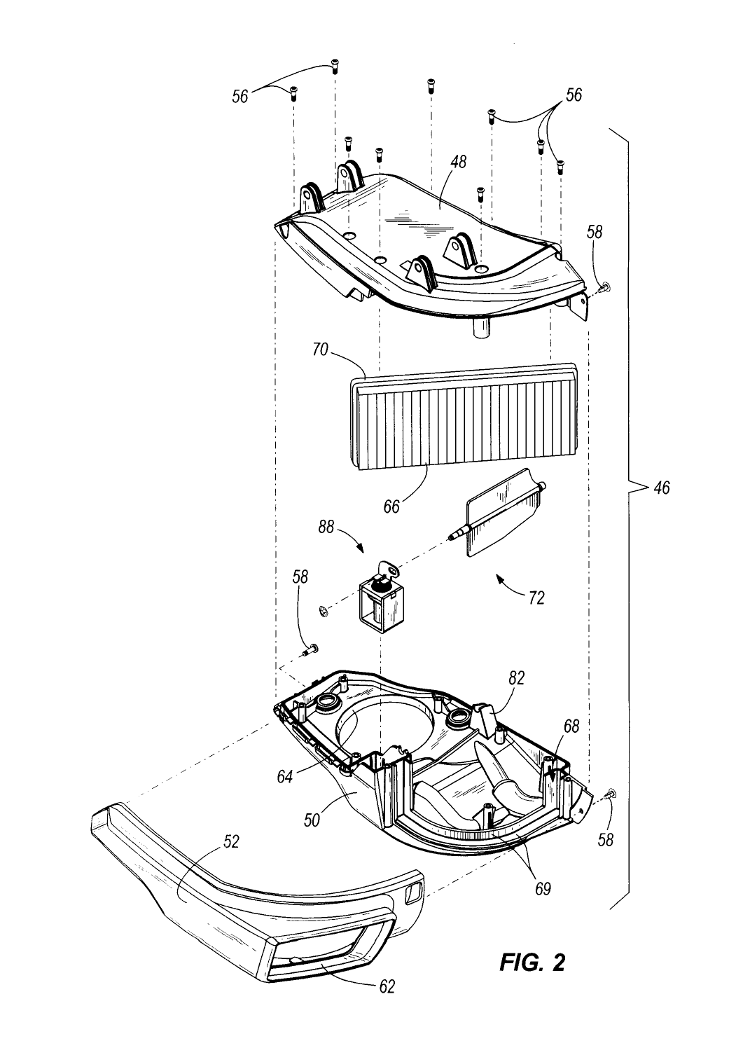

As shown in FIG. 1, the motorcycle 20 includes an air box assembly, simply referred to hereinafter as the air box 46. The air box 46 includes an upper housing 48, a lower housing 50, and a front fascia 52, as shown in FIG. 2. The upper housing 48 and the lower housing 50 are coupled together by fasteners 56. Additional fasteners 58 are used to couple the front fascia 52 to the upper housing 48 and lower housing 50.

With continued reference to FIG. 2, the upper housing 48 and the lower housing 50 combine to define a flow passage through the air box 46. The front fascia 52 includes an inlet opening 62 for receiving intake air into the air box 46. The lower housing 50 includes an outlet opening 64 for supplying the intake air to the throttle assembly. A filter element 66 is positioned adjacent the inlet opening 62. The filter element 66 separates debris from the intake air. The lower housing 50 includes a retention mechanism such as a channel or groove 68 formed of curved surfaces 69 for receiving and retaining an outer rim 70 of the filter element 66. The filter element 66 is securely positioned in a curved orientation by the groove 68 of the lower housing 50.

As shown in FIG. 2, the filter element 66 is substantially planar or non-curved in its natural, unstressed state. The filter element 66 is formed flat rather than pre-curved to reduce manufacturing complexity and cost, among other factors. The filter element 66 is curved in-use to allow a high amount of surface area without taking up an excessive amount of space. During assembly, the filter element 66 is forcibly curved from the flat, unstressed state into a stressed state in which the filter element 66 assumes a curved profile consistent with the groove 68. The curved filter element 66 takes up less space in the air box 46 compared to mounting in a flat orientation, and it offers more surface area in the same width. Greater surface area allows a higher flow rate of intake air for increased performance without sacrificing filtering ability.

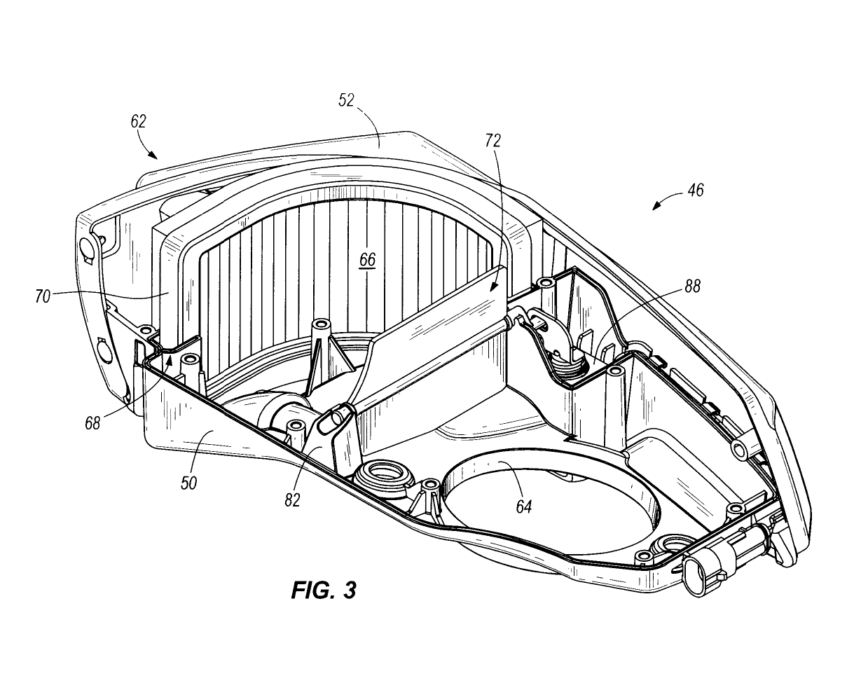

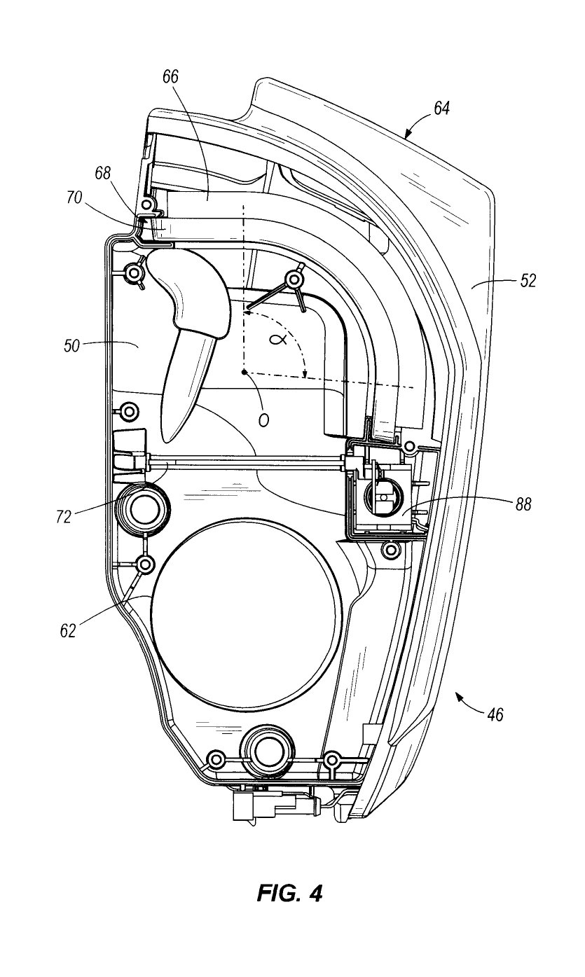

FIGS. 3 and 4 illustrate the curvature of the filter element 66. The curvature, or curved profile, of the filter element 66 is consistent with that of the groove 68. A portion of the curvature of the groove 68 and that of the filter element 66 has a center at the imaginary point O (two-dimensionally representing an axis in FIG. 4). Those portions of the groove 68 and the filter element 66 extend along an arc, centered at point O, of about 95 degrees as indicated by the angle α. In some embodiments, the groove 68 and/or the filter element 66 extend along an arc or a substantially arc-shaped path with an angle between the ends of curvature of between about 45 degrees and about 180 degrees.

In some embodiments, the groove 68 and/or the filter element 66 include portions with varied radii and/or centers of curvature, such that they do not form an exact portion of a circle. However, as used herein, an arc or arc-shaped path includes at least paths and shapes that have one or more straight sections, sections of varying radius, and sections with varying centers of curvature. The angle of curvature of the groove 68 and/or the filter element 66 may either be expressed by measuring a single section having a singular radius and center of curvature, or by measuring the resultant angle that exists between two or more portions that are curved or straight.

In some embodiments, a valve 72 is positioned in the air box 46. Specifically, the valve 72 is positioned in the flow passage between the inlet opening 62 and the outlet opening 64. In this position, the valve 72 is downstream of the filter element 66 and upstream of the throttle assembly. Therefore, the valve 72 is shielded by the filter element 66 from the debris that the filter element 66 separates from the intake air. Also, the valve 72 is positioned to vary the intake passage geometry and affect the flow of intake air through the intake passage before the intake air reaches the throttle assembly. The valve 72 is coupled to an actuator 88. In the illustrated embodiment, the actuator 88 is a solenoid configured to selectively rotate the valve 72.

As mentioned above, the filter element 66 shields the valve 72 from debris that is present in unfiltered intake air. Likewise, the actuator 88 is shielded from debris by the filter element 66. The positioning of the valve 72 and the actuator 88 inside the air box 46 downstream of the filter element 66 provides protection against impact damage, clogging of the intake passage, and jamming of the moving parts. Also, the filter element 66 shields electrical components and connections associated with the actuator 88. The filter element 66 keeps the electrical components and connections clean, extending the useful life of the actuator 88.

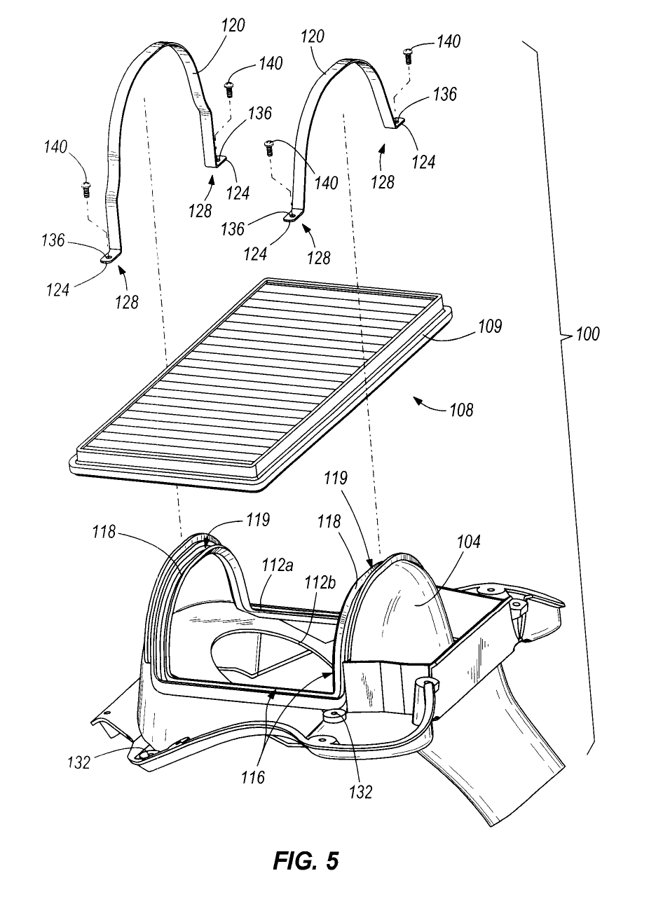

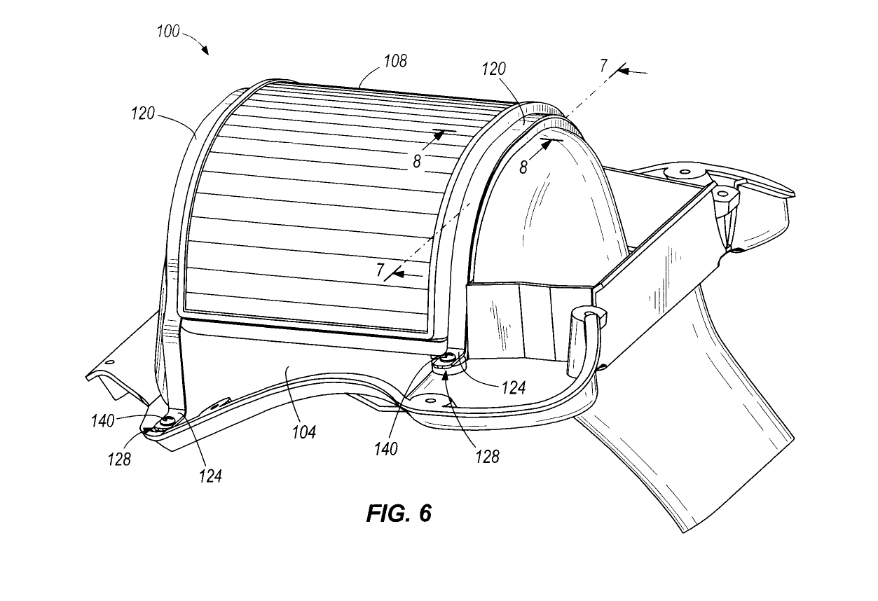

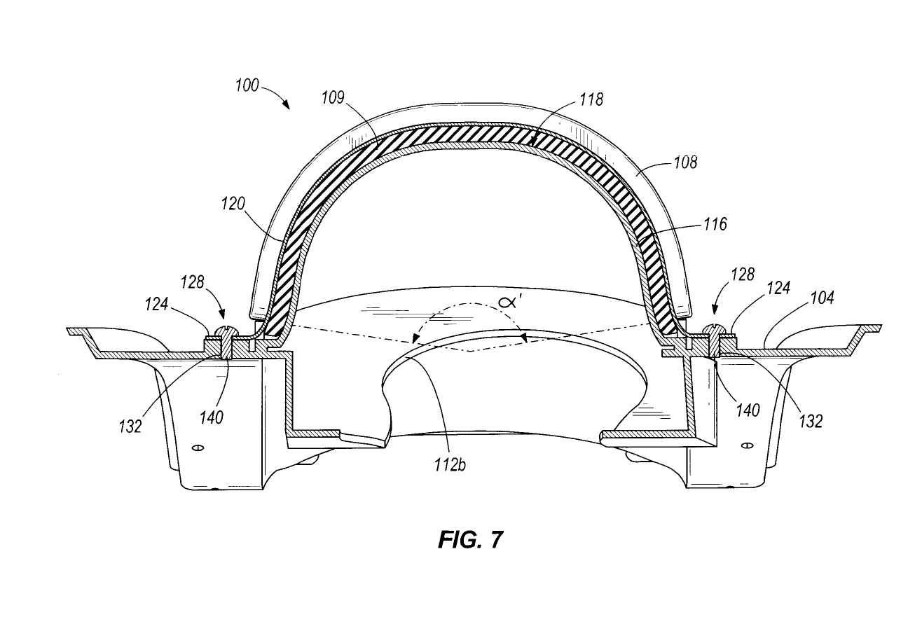

FIGS. 5-8 illustrate an air box 100 of a second embodiment. The air box 100 includes a housing 104 and a filter element 108, which has a peripheral rim 109. The housing 104 is formed with a pair of openings 112a and 112b. The housing 104 includes a flange 116 having curved surfaces 118 adjacent the first opening 112a and extending from one side of the housing 104 to the opposite side. The second opening 112b is directly below the first opening 112a and directs airflow into a throttle assembly (not shown). The housing 104 is generally dome-shaped, and the filter element 108 wraps over the housing 104 with the peripheral rim 109 adjacent the flange 116 on all sides. A portion of the filter element 108 is arched in a substantially arc-shaped bend having an angle α′ of approximately 165 degrees (see FIG. 7) when the peripheral rim 109 is positioned along the flange 116 (i.e., when “in-use”). In some embodiments, the filter element 108 is bent to an angle between the ends of curvature between about 90 degrees and about 270 degrees. In some embodiments, the filter element 108 extends exactly along an arc portion of a circle.

As discussed above with reference to the first embodiment, the angle of curvature of the tilter element 108 may be expressed by measuring one substantially arc-shaped portion or a sum of two or more portions that are either curved or straight. For example, the filter element 108 as shown in FIG. 7, is not formed of a single circular arc having one center of curvature and one radius. However, the filter element 108 has a non-planar shape in which the two ends are offset with one another by the angle α′.

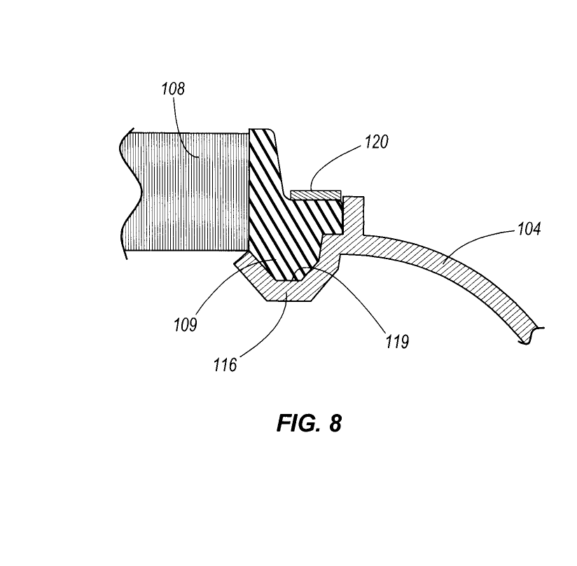

As best shown in the cross-sectional view of FIG. 8, the flange 116 forms a channel 119 along the curved surfaces 118 for receiving the peripheral rim 109 of the filter element 108. The channel 119 is generally U-shaped to conform to the shape of the peripheral rim 109 and form a sealing relationship therewith. Alternately, the flange 116 can be formed in a V-shaped channel, a square-edged trough, or may be substantially flat and not formed into a channel at all. In the illustrated embodiment, the channel 119 extends not only along the two curved surfaces 118, but entirely around the flange 116 and the first opening 112a in the housing 104.

A retention mechanism retains the filter element 108 in the curved orientation, the peripheral rim 109 of the filter element 108 tucked into the channel 119 formed at the flange 116 of the housing 104. The retention mechanism includes straps 120 that extend across the filter element 108. The straps 120 are formed of a substantially rigid pre-formed material. In other embodiments, the straps 120 are formed of a material (not necessarily pre-formed) having elastic properties such that they may be stretched across the filter element 108. The straps 120 are configured to hold the filter element 108 stationary and in a desired position with respect the flange 116. The ends 124 of the straps 120 are formed with mounting features 128, which engage openings 132 in the housing 104. The mounting features 128 include apertures 136 for receiving fasteners 140. The fasteners 140 engage the openings 132 to secure the ends 124 of the straps 120 to the housing 104.

The filter element 108 is formed as a substantially flat, non-curved element (prior to installation on the housing 104). In this regard, the filter element 108 is similar to the filter element 66 described above. The flat filter element 108 is simple to manufacture, and the curved in-use orientation allows high surface area in a small amount of space. During assembly, the filter element 108 is forcibly curved from the flat, unstressed state into a stressed state in which the filter element 108 assumes a curved profile consistent with the curved surfaces 118 of the flange 116.

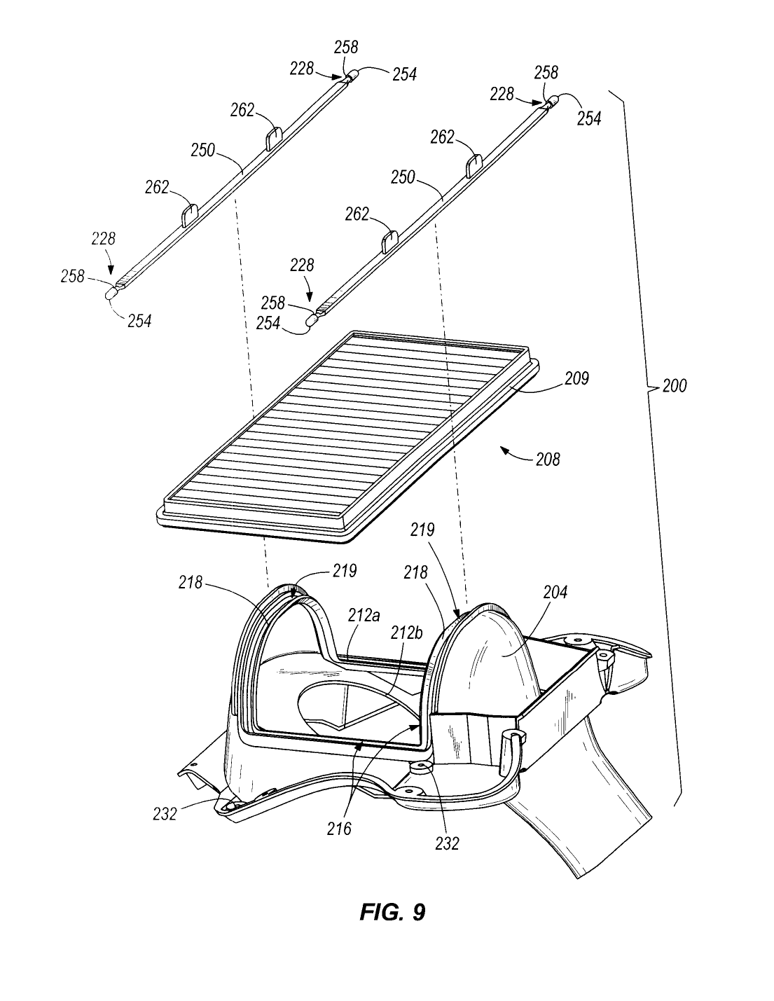

FIGS. 9-11 illustrate an air box 200 of a third embodiment. The air box 200 is similar to the air box 100 of FIGS. 5-8 in most respects. Like parts are represented by like reference numerals (in the 200's rather than 100's). The air box 200 features additional modifications to the air box 100 illustrated in FIGS. 5-8. The air box 200 includes two substantially elastic straps 250, which serve as a retention mechanism for keeping the filter element 208, and specifically, the peripheral rim 209 of the filter element 208, in position and stationary with respect to the housing 204.

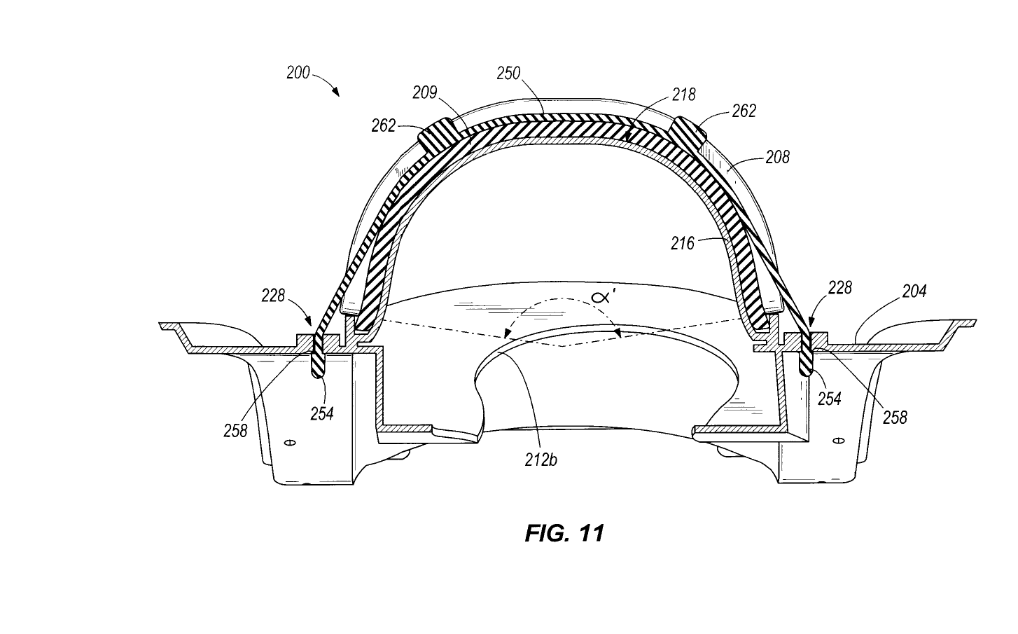

The straps 250 are each formed with mounting features 228 in the form of two bullet-shaped ends 254 for mounting the straps 250 to the housing 204. The ends 254 are generally round in cross-section and each includes a barb or shoulder 258. The ends 254 are radially compressed when inserted into the openings 232 in the housing 204 to make a substantially air-tight seal therebetween. The round shape enhances the sealing capability between the straps 250 and the openings 232 (as compared to a cross-sectional shape having multiple edges defining corners). In alternate embodiments, the ends 254 are substantially flat and/or have multiple sealing edges. The outer diameters of the shoulders 258 are larger than the diameters of the openings 232 in the housing 204, so that the ends 254 are retained by the shoulders 258 when inserted through the openings 232 as shown in FIG. 11. Therefore, once inserted through the openings 232, the ends 254 are not readily removable. However, changing of the filter element 208 is easily enabled without removing the ends 254 of the straps 250.

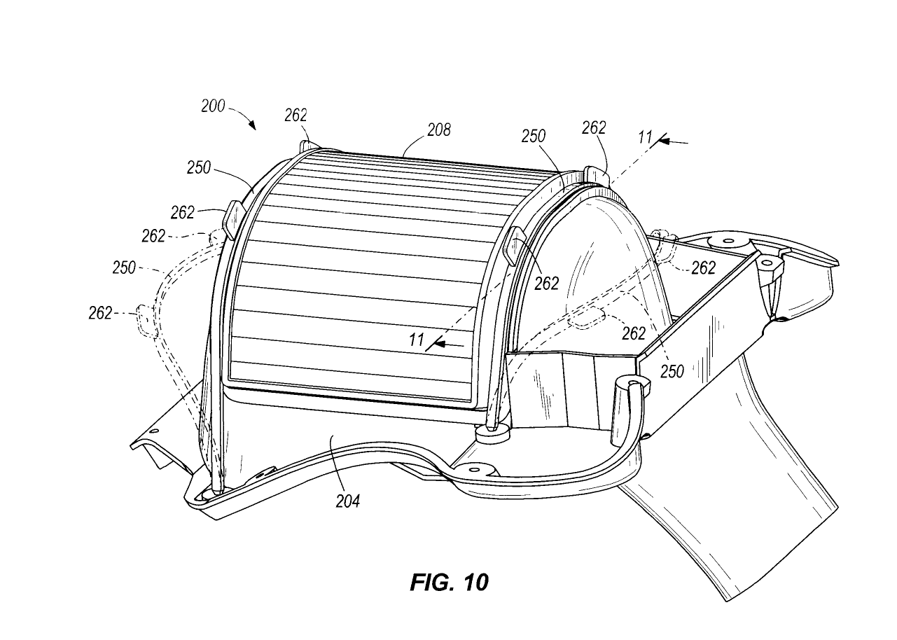

Each strap 250 is formed to include two tabs 262, which project outwardly from the filter element 208 and the housing 204. When it is desired to remove the filter element 208 for cleaning or replacement, the two tabs 262 provide locations for a user to grasp and elastically stretch out the strap 250 in order to remove it from the peripheral rim 209 of the filter element 208. Once stretched, each strap 250 is pulled off (outwardly away from the center of the filter element 208). Once removed from the peripheral rim 209, the user may release the straps 250, which become relaxed in a position off the ends of the housing 204 as shown by the phantom lines in FIG. 10. The filter element 208 is then accessible to be lifted away from the housing 204. When the filter element 208 is replaced, the user grasps the tabs 262 to stretch the straps 250 and replace them over the peripheral rim 209 of the filter element 208.

What is claimed is:

1. An air filter assembly for a motorcycle including an engine having an air intake passageway, the air filter assembly comprising:
a housing at least partially defining the air intake passageway, the housing including an opening and a curved surface adjacent to the opening;
an air filter formed to be substantially planar in an unrestrained condition, the air filter deformed against the curved surface to conform to the curved surface; and
a retention mechanism engaged with the air filter.

2. The air filter assembly of claim 1, wherein the retention mechanism includes a strap positioned to hold the air filter against the curved surface.

3. The air filter assembly of claim 2, wherein the strap is formed of an elastic material.

4. The air filter assembly of claim 2, wherein the strap includes an end releasably attached to the housing.

5. The air filter assembly of claim 1, wherein the retention mechanism includes a groove formed in the housing.

6. The air filter assembly of claim 1, wherein the air filter is curved in an arc of between about 45 degrees and about 270 degrees when held by the retention mechanism.

7. The air filter assembly of claim 6, wherein the air filter is curved in an arc of about 95 degrees.

8. The air filter assembly of claim 6, wherein the air filter is curved in an arc of about 165 degrees.

9. A motorcycle comprising:
an engine configured to provide power to a wheel of the motorcycle; and
an air box configured to direct intake air into the engine, the air box including
an air filter having a pre-assembled condition and an assembled condition, the air filter being substantially flat and unstressed in the pre-assembled condition and having a curved orientation in the assembled condition; and
a housing including a curved surface, wherein the air filter is deformed against the curved surface to conform to the curved surface when the air filter is in the assembled condition.

10. The motorcycle of claim 9, wherein the curved surface forms part of a retaining groove for maintaining the air filter in the assembled condition.

11. The motorcycle of claim 9, wherein air filter is curved in an arc of between about 45 degrees and about 270 degrees in the assembled condition.

12. The motorcycle of claim 11, wherein the air filter is curved in an arc of about 95 degrees.

13. The air filter configuration of claim 11, wherein the air filter is curved in an arc of about 165 degrees.

14. A method of assembling a motorcycle having an engine, the method comprising:
providing an air box housing configured to route intake air to a throttle assembly of the engine;
providing an air filter in a substantially unstressed state;
stressing the air filter to a curved orientation; and
mounting the air filter to the air box housing in the curved orientation.

15. The method of claim 14, further comprising bending the air filter into a curved, stressed state to obtain the curved orientation.

16. The method of claim 15, further comprising bending the air filter into an arc of between about 45 degrees and about 270 degrees.

17. The method of claim 15, further comprising inserting the air filter into a groove in the air box housing.

18. The method of claim 14, further comprising retaining the air filter in the curved orientation with a strap.

19. The method of claim 18, further comprising stretching the strap over a convex side of the air filter and coupling at least one end of the strap to the air box housing.

20. The method of claim 19, further comprising securing two opposing ends of the strap to the air box housing at respective openings.
